(19) United States
(12) Patent Application Publication
(10) Pub. No.: US 2009/0142579 A1
(43) Pub. Date: Jun. 4, 2009

(54) HIGH SECURITY WINDOW FILM WITH SENSING CAPABILITY

(75) Inventor: Richard A. Smith, El Dorado Hills, CA (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/948,625

(22) Filed: Nov. 30, 2007

(51) Int. Cl. B32B 5/16; B32B 27/00

(52) U.S. Cl. 428/323; 428/421; 977/742

(57) ABSTRACT

The present disclosure is directed to an electrical circuit-forming film composition applied to a window in order to provide security and heat sensing capabilities. The composition is comprised of a plurality of layers, at least one of which is provided with a piezoelectric and pyroelectric capability, and conductive electrode layers formed on each side of said layer.

### FIELD OF THE INVENTION

The present invention is directed to an electrical circuit-forming film composition applied to a window in order to provide security and heat sensing capabilities. The composition is a security film comprised of a plurality of layers, at least one of which layers is provided with a piezoelectric capability. Conductive electrode layers are positioned on each side of the piezoelectric layer. An electrical connection provided between the security film and integrated circuitry appropriate to a sensing and alarm system creates a mechanism for providing a security alert in the case of attempted or actual window breakage, such as by cutting and fracturing, and thus the means to alert of the possibility of forced entry by a criminal perpetrator.

### BACKGROUND OF THE INVENTION

Window breakage security systems may employ a shock sensor, such as a piezo electric ceramic or an acoustic detector that employs microphones, or another type of detector that detects window breakage. Such sensors, however, are imperfect, in part due to the levels of sensitivity to which they must be tuned. For example, when set to a high level of detection, such sensors are relatively sensitive and therefore prone to false alarms. When set to a lower level of sensitivity in order to reduce false alarms, such sensors may fail to detect actual events of breakage, such as by high velocity impact. Further, such systems do not provide detection against attempts to break a window by heating same to extremely high, fracture-causing temperatures.

Among the reasons that a film may be applied to a window are: to increase the resistance to breakage, such as by direct force or by percussive effect (that is, explosions or blasts), to provide protection in the case of a storm, to provide protection against electromagnetic interference (EMI), to improve energy efficiency of the premises, and to protect against UV radiation. With respect to preventing window breakage, window film is not fail proof it can be defeated with additional effort. Also, conventional window film does not generate some measurable factor that could signal a breakage, or attempted breakage of the window.

### SUMMARY OF THE INVENTION

In one aspect, the present invention is a security film for a window that upon application of force, undergoes a change that generates an electrical potential that can be used to sense and detect window breakage. Thus, the window coated with the inventive security film disclosed herein can be used in an alarm or security system.

In another aspect the security film of the present invention possesses piezoelectric properties, and thus generates an electrical potential in response to an applied mechanical stress. In a further aspect, the security window film is pyroelectric, and thus has the ability to generate an electrical potential when the film is heated or cooled.

The security film of the present invention can form part of an electrical circuit that, when applied to a window, generates an electrical signal in response to impact or heat. The electrical signal can be detected in a sensing or alarm system. The film composition is comprised of a plurality of layers; at least one of such layers is an intermediate layer exhibiting piezoelectric capability. Further, a preferably transparent conductive electrode layers are formed on each side of the piezoelectric layer. Providing an electrical connection between the electrodes and the processing circuitry of an alarm system creates a mechanism for providing a security alert in the case of attempted window breakage, or actual window breakage, thereby alerting an interested party of the possibility of forced entry by a criminal perpetrator.

The present invention advantageously makes it possible to have a window film that provides the breakage resistance of conventional films while providing a force or heat detecting capability produced by the piezoelectric and pyroelectric properties of the film, which properties allow for the sensing and signaling of a breakage, whether by intrusion, or events such as external blast or even storm damage.

### BRIEF DESCRIPTION OF THE FIGURES

FIG. 1 is a cross-sectional view of a window provided with security film of the present invention.

FIG. 2 is a cross-sectional view of a second embodiment of a window provided with a security film of the present invention.

### DETAILED DESCRIPTION OF THE PREFERRED EMBODIMENT

One desirable property of the security film of the present invention that should be evident is that the security film should be transparent, as the intention is to apply the films to a window. With respect to a material providing piezoelectric and pyroelectric capabilities, while also being transparent, a suitable material is the polyvinylidine fluoride (PVDF) polymer, which is obtainable from commercial suppliers as a film. This material is marketed under the KYNAR® trademark. Co-polymers of polyvinylidine fluoride, such as copolymer of PVDF and trifluorethyene (TrEE) or a copolymer of PVDF and tetrafluoroethylene (TFE) are also well suited for use as a piezoelectric layer.

The security film of the present invention includes conductive electrode layers that are applied to each side of the intermediate PVDF layer. A suitable conductive electrode material is indium tin oxide, which is both transparent and conductive in thin layers. Carbon nanotube coatings applied to each side of the PVDF layer are also well suited for use as the electrode layer, due to their conductivity and transparency. Carbon nanotube conductive layers can be applied to the PVDF layer by applying a film forming dispersion to the PVDF layer by techniques known in the art.

Indium tin oxide or tin-doped indium oxide (hereinafter ITO) is a mixture of indium (III) oxide (In₂O₃) and tin (IV) oxide (SnO₂). ITO thin films, such as the films applied here, are on the order of about 100 nm to about 200 nm in thickness. ITO coatings can be deposited onto the piezoelectric and pyroelectric film. The electrode layers can be applied by electron beam evaporation, physical vapor deposition, vacuum deposition, or by sputter deposition techniques.

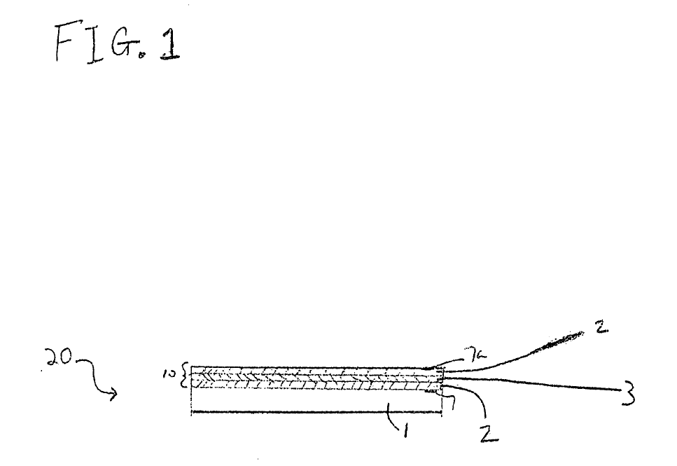

Turning now to FIG. 1, a window 20 having the security film 10 of the present invention comprises at least one glass layer 1 upon which the security film is applied. Again, the security film includes an electrode forming coating or film 2 applied to each side of a film 3 formed from piezoelectric and pyroelectric material, such as PVDF or a copolymer thereof. As indicated above, ITO is a well-suited electrode forming coating for this application, as it is both transparent and conductive. The ITO can be applied in the manner indicated above.

Among polymers, PVDF films and co-polymers thereof possess the some of the highest, if not the highest, values of piezoelectric and pyroelectric constants. These films are first subjected to stretching and then to a high electric field (or corona charge) at an elevated temperature to provide the highest possible piezoelectric constant and the highest possible pyroelectric constant. The security film 10 constructed of piezo/pyroelectric film layer 3 and electrode layers 2, is bonded to a glass window with a suitable adhesive, such as ARALDITE® and BONDiT® adhesives, ARALDITE® 2026 is a clear polyurethane based adhesive that bonds glass and thermoplastics and is available from Freeman MSC, Avon Ohio. BONDiT® A-3 bonding agent can also bond thermoplastics and glass and is available from Reltek LLC of Santa Rosa Calif. Alternatively, the film can be provided with a high mass pressure sensitive weatherable acrylate adhesive applied uniformly over the adhering surface. The adhesive should be essentially optically flat and should not appear distorted when the viewed from a distance of ten feet at angles up to 45° from either side of the glass, and the film should not require sealing around the edges of the applied film system with a lacquer or other substance in order to prevent moisture or free water from penetrating under the film system.

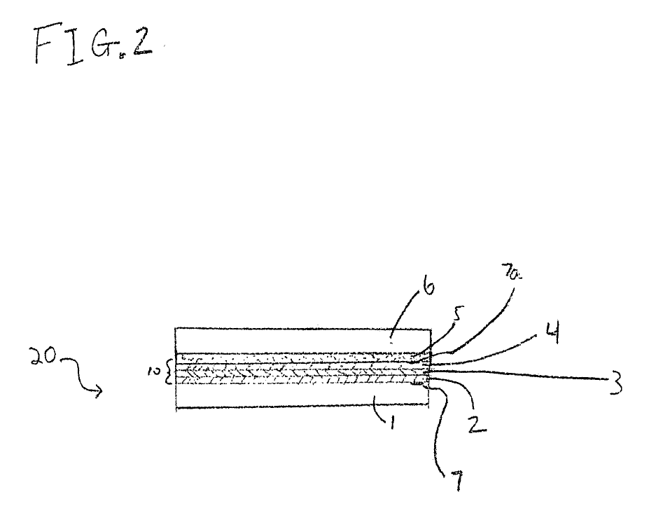

As shown in FIG. 2, protective layer 5 of polyvinylbutyral to enhance toughness and binding of the layers may be applied over the electrode layer 4. In certain applications, it may be advantageous to position a second pane or sheet of glass 6 over the security film, such that the security film is positioned in between a first glass sheet and a second glass sheet. In other words, an optional layer of glass may be applied over the coated layers and films to form a sandwiched security composite.

Electrical terminals 7, 7a are in electrical contact with the communication with the electrodes such as at one corner of the coated sheet. The electrical terminals can be positioned anywhere on the sheet, but at an edge thereof is a desirable location.

The security film of the present invention can be applied to conventional window glass used in commercial and residential properties. Prior to applying the security film to a window, the composite electrode-security film described herein can be pre-manufactured into rolls or sheets. In one contemplated usage, sheets of security film can be cut to the size of the window and applied thereto at any desirable location, such as the site where the windows are manufactured or even at the construction site where the windows are installed. In any event, electrode terminals would then be applied to a location on the security film, such as a location corresponding to a corner of the window.

In an alternative arrangement, terminals can be preinstalled in one or more corners of a larger film prior to cutting the film. In this arrangement, the electrode terminals are installed prior to cutting of film and its subsequent application to a window. As an example, a sheet of security film, sized large enough to be applied to multiple windows, can be provided with preinstalled terminals in one or more of its corners, which when cut to window size, provides a plurality of terminal-containing sheets. With this arrangement, it would be advantageous to provide a terminal in each of the four sheet corners.

In yet another arrangement, sheets can be produced in a range of sizes, which sheet sizes are in multiples of standard window sizes, with sheet size allowance being provided so that the film could be given a final trim at the time of installation. Each of these sheets would be provided with the electrode terminals in one corner thereof, so then when cut to size, the security film will be provided with a terminal.

The electrode terminals 7 and 7a are in communication with electrical circuitry for transmitting a potential across the security film. The terminals may be a tin-plated or gold plated terminal adhered to the ITO terminals by a conductive epoxy. Specifically, the terminals interface to signal conditioning and processing circuitry, which would further interface with a security system of other type of monitoring system. The signal conditioning would be configured to filter and amplify impact and vibration stimulus, and another path would filter and amplify response to heat stimulus. The processing circuitry, exemplified by a micro-controller, processes the conditioned signals and provides the signal or warning of possible break-in events.

When a window to which the security film is attacked—by direct force, by a percussive action, or other kind of impact—an electrical potential is generated in the piezoelectric layer, which potential is detected in the circuitry that generates an alarm or warning signal. Through the electrodes, the security film is electrically connected to circuitry that senses whether the threshold amplitude, selected to indicate whether the window has been subjected to a force representing, at the least, an attempted break in, which can be translated to an alarm or warning signal. Likewise, when the security film-possessing window is torched or subjected to extreme heat from some other source, and electrical potential is generated in the pyroelectric layer, generating a current through the electrodes, though the terminals, and the electrical circuitry that triggers an alarm or warning signal.

What is claimed is:

1. A security film for application to a window to detect breakage comprising:
a substantially transparent piezoelectric layer positioned between substantially transparent electrical conducting layers.

2. The security film of claim 1 wherein the piezoelectric layer is comprised of a material exhibiting a relatively high piezoelectric constant, the material selected from the group consisting of a PVDF polymer or a PVDF-containing copolymer.

3. The security film of claim 2 wherein the PVDF-containing copolymer is selected from the group consisting of a co-polymer of PVDF and trifluorethylene and a copolymer of PVDF and tetrafluoroethylene.

4. The security film of claim 1 wherein the electrical conducting layers comprise a material selected from the group consisting of indium tin oxide and carbon nanotubes.

5. The security film of claim 2 wherein the electrical conducting layers comprise a material selected from the group consisting of indium tin oxide and carbon nanotubes.

6. The security film of claim 3 wherein the electrical conducting layers comprise a material selected from the group consisting of indium tin oxide and carbon nanotubes.

7. The security film of claim 1 comprising:
a transparent layer of PVDF exhibiting a relatively high piezoelectric constant positioned between substantially transparent electrical conducting layers comprised of indium tin oxide.

8. A window having a security film applied thereto, comprising:
a window;
a security film applied to the window, the security film comprising a substantially transparent piezoelectric layer positioned between substantially transparent electrical conducting layers.

9. The window of claim 8 wherein the piezoelectric layer is comprised of a material exhibiting a relatively high piezoelectric constant, the material selected from the group consisting of a PVDF polymer or a PVDF-containing copolymer.

10. The window of claim 9 wherein the PVDF-containing copolymer is selected from the group consisting of a co-polymer of PVDF and trifluorethylene and a copolymer of PVDF and tetrafluoroethylene.

11. The window of claim 8 wherein the electrical conducting layers comprise a material selected from the group consisting of indium tin oxide and carbon nanotubes.

12. The window of claim 9 wherein the electrical conducting layers comprise a material selected from the group consisting of indium tin oxide and carbon nanotubes.

13. The window of claim 10 wherein the electrical conducting layers comprise a material selected from the group consisting of indium tin oxide and carbon nanotubes.

14. A window having a security film for application to a window to detect breakage comprising:
a window upon which is deposited a security film comprising a layer of PVDF exhibiting a relatively high piezoelectric constant positioned between substantially transparent electrical conducting layers comprised of indium tin oxide.
